(19) United States
(12) Patent Application Publication
(10) Pub. No.: US 2023/0354161 A1
(43) Pub. Date: Nov. 2, 2023

(54) FREQUENCY BAND HAVING VARIABLE DUPLEX SPACING

(71) Applicant: Apple Inc., Cupertino, CA (US)

(72) Inventors: Elmar Wagner, Taufkirchen (DE); Anatoliy S. Ioffe, Sunnyvale, CA (US)

(21) Appl. No.: 18/084,132

(22) Filed: Dec. 19, 2022

Related U.S. Application Data
(60) Provisional application No. 63/335,563, filed on Apr. 27, 2022.

(51) Int. Cl. H04W 48/10; H04W 72/51; H04W 72/30; H04W 72/0453

(52) U.S. Cl. CPC H04W 48/10; H04W 72/51; H04W 72/30; H04W 72/0453

(57) ABSTRACT

A communication network broadcasts an indication of a frequency band and an indication of a partial frequency band. User equipment receives the broadcasted indications, if it may operate on the full frequency band, transmits an indication. The network then configures the user equipment to operate on the full frequency band, and the user equipment communicates with the network using the full frequency band. Otherwise, the user equipment transmits an indication that it may operate on the partial frequency band, the network configures the user equipment to operate on the partial frequency band, and the user equipment communicates with the network using the partial frequency band.

### CROSS-REFERENCE TO RELATED APPLICATIONS

This application claims priority to U.S. Provisional Application No. 63/335,563, filed Apr. 27, 2022, entitled “FREQUENCY BAND HAVING VARIABLE DUPLEX SPACING,” the disclosure of which is incorporated by reference herein in its entirety for all purposes.

### BACKGROUND

The present disclosure relates generally to wireless communication, and more specifically to communicating on a frequency band that may be specified for use differently in different geographical regions.

The Third Generation Partnership Project (3GPP) specifies certain frequency bands for use with certain radio access technologies (RATs). For example, the 3GPP specifies the 600 megahertz (MHz) frequency band for use by a frequency range 1 (FR1) fifth generation (5G) New Radio (NR) RAT as the n71 frequency band in at least some geographical regions (e.g., the United States). The n71 band includes two 35 MHz wide frequency ranges, one for downlink (e g, from 617 MHz to 652 MHz) and one for uplink (e.g., from 663 MHz to 698 MHz). At least some operators or interest groups, such as Asia Pacific Telecommunity (APT), desire to specify a new frequency band to use the 600 MHz frequency band in the APT region (e.g., the Asia Pacific geographical region). However, there may be different and/or more efficient forms of usage for the 600 MHz frequency band, beyond simply designating the 600 MHz frequency band as the n71 frequency band.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In one embodiment, an electronic device includes a transmitter that transmits a transmission signal to user equipment, a receiver that receives a receive signal from the user equipment, and processing circuitry. The processing circuitry causes the transmitter to transmit an indication of a frequency band and a partial frequency band to the user equipment. The frequency band includes the partial frequency band. The processing circuitry also causes the receiver to receive an indication of a capability of the user equipment to operate on the frequency band or the partial frequency band. The processing circuitry further configures, via the transmitter, the user equipment for operation on the frequency band based on the indication indicating that the user equipment is capable of operating on the frequency band, and configures, via the transmitter, the user equipment for operation on the partial frequency band based on the indication indicating that the user equipment is capable of operating on the partial frequency band.

In another embodiment, a method performed by user equipment includes receiving, at a receiver of the user equipment, an indication of a frequency band and a partial frequency band. The frequency band includes the partial frequency band. The method also includes transmitting, by a transmitter of the user equipment, an indication of capability of operating on the frequency band or the partial frequency band, and receiving, at the receiver, a configuration based on the indication of the capability of operating on the frequency band or the partial frequency band. The method further includes communicating, using the transmitter or the receiver, based on the configuration.

In yet another embodiment, one or more tangible, non-transitory, machine-readable media store instructions that cause processing circuitry of a base station to cause a transmitter of the base station to transmit an indication of a frequency band and a partial frequency band to user equipment, and cause a receiver of the base station to receive an indication of a capability of the user equipment to operate on the frequency band or the partial frequency band. The instructions also cause the processing circuitry to cause the transmitter to transmit a configuration to the user equipment enabling operation on the frequency band, and cause the transmitter or the receiver to communicate with the user equipment using the frequency band, based on the indication indicating that the user equipment is capable of operating on the frequency band. The instructions further cause the processing circuitry to cause the transmitter to transmit a configuration to the user equipment enabling operation on the partial frequency band, and cause the transmitter or the receiver to communicate with the user equipment using the partial frequency band, based on the indication indicating that the user equipment is capable of operating on the partial frequency band.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings described below in which like numerals refer to like parts.

FIG. 1 is a block diagram of user equipment, according to embodiments of the present disclosure;

FIG. 2 is a functional diagram of the user equipment of FIG. 1, according to embodiments of the present disclosure;

FIG. 3 is a schematic diagram of a transmitter of the user equipment of FIG. 1, according to embodiments of the present disclosure;

FIG. 4 is a schematic diagram of a receiver of the user equipment of FIG. 1, according to y embodiments of the present disclosure;

FIG. 5 is a schematic diagram of a communication system including the user equipment of FIG. 1 communicatively coupled to a wireless communication network supported by base stations, according to embodiments of the present disclosure;

FIG. 6 is a frequency diagram of an n71 frequency band;

FIG. 7 is a frequency diagram of a frequency band in the 600 megahertz (MHz) frequency range, according to embodiments of the present disclosure; and

FIG. 8 is a flowchart of a method to allocated channels of the frequency band of FIG. 6, according to embodiments of the present disclosure.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Furthermore, the particular features, structures, or characteristics may be combined in any suitable manner in one or more embodiments. Use of the terms “approximately,” “near,” “about,” “close to,” and/or “substantially” should be understood to mean including close to a target (e.g., design, value, amount), such as within a margin of any suitable or contemplatable error (e.g., within 0.1% of a target, within 1% of a target, within 5% of a target, within 10% of a target, within 25% of a target, and so on). Moreover, it should be understood that any exact values, numbers, measurements, and so on, provided herein, are contemplated to include approximations (e.g., within a margin of suitable or contemplatable error) of the exact values, numbers, measurements, and so on.

This disclosure is directed to communicating on a frequency band that may be specified for use differently in different geographical regions. The Third Generation Partnership Project (3GPP) specifies certain frequency bands for use with certain radio access technologies (RATs). For example, the 3GPP specifies the 600 megahertz (MHz) frequency band for use by a frequency range 1 (FR1) fifth generation (5G) New Radio (NR) RAT as the n71 frequency band in at least some geographical regions (e.g., the United States). The n71 band includes two 35 MHz wide frequency ranges, one for downlink (e.g., from 617 MHz to 652 MHz) and one for uplink (e.g., from 663 MHz to 698 MHz). At least some operators or interest groups, such as Asia Pacific Telecommunity (APT), desire to specify a new frequency band to use the 600 MHz frequency band in the APT region (e.g., the Asia Pacific geographical region).

In the simplest example, the 600 MHz frequency band may be designated as the n71 frequency band, such that it is divided into the two 35 MHz wide frequency ranges, one for downlink and one for uplink. However, because the 600 MHz frequency band has more bandwidth to be used than the total width of the two 35 MHz wide frequency ranges (e.g., even when including a guard band or buffer of, for example 11 MHz) in certain regions, it may be more efficient to expand usage of the 600 MHz frequency band beyond the usage defined by the n71 frequency band in these regions. For example, each of the two 35 MHz wide frequency ranges may be extended by 5 MHz, such that a first 40 MHz frequency range is used for downlink, and a second 40 MHz frequency range is used for uplink. However, a duplexer of user equipment may be designed to duplex or separate downlink signals from uplink signals based on their respective frequency ranges (e.g., a difference between center frequencies of a downlink channel and an uplink channel, also referred to as a duplex distance). For the n71 frequency band, where the downlink range and the uplink range are each divided into seven 5 MHz wide channels, the duplex distance may include 46 MHz (e.g., from a center frequency of a first downlink channel to a center frequency of a first uplink channel, from a center frequency of a second downlink channel to a center frequency of a second uplink channel, and so on). If the n71 frequency band were extended by 5 MHz in each direction (e.g., adding 5 MHz to the beginning of the 40 MHz downlink frequency range, and adding 5 MHz to the end of 40 MHz uplink frequency range), then the duplex distance would change to 51 MHz, and current (e.g., legacy) devices that are configured to operate on and duplex n71 frequency band would not be able to operate on and duplex this extended band.

Embodiments herein provide various systems, apparatuses, and techniques to communicate on a frequency band (e.g., the 600 MHz frequency band) that may be specified for use differently in different geographical regions. In particular, a communication network (e.g., a 5th generation (5G)/New Radio (NR) network, a 4th generation (4G)/long term evolution (LTE®) network, a 6th generation (6G) or greater than 6G network, and so on), via a base station, may broadcast an indication of the frequency band and an indication of a partial frequency band. The frequency band may include a greater range than the partial frequency band, and the partial frequency band may be compatible with certain (e.g., legacy) user equipment, while the full frequency band may be compatible with other (e.g., more recent) user equipment. For example, the partial frequency band may include the n71 frequency band, while the full frequency band may include the extended n71 frequency band, where the downlink frequency range of the n71 frequency band is extended by 5 MHz, and the uplink frequency range of the n71 frequency band is extended by 5 MHz. In some cases, the partial frequency band may be applicable to certain geographical regions (e.g., the United States), while the full frequency band may be applicable to other geographical regions (e.g., the Asia Pacific region).

The user equipment may receive the broadcasted indications, and determine whether it may operate on the full frequency band. If so, the user equipment may transmit an indication that it may operate on the full frequency band to the base station (e.g. via capability signaling, via modified maximum power reduction (MPR) behavior signaling, or some other method specified in the communications protocol). The network may then configure the user equipment to operate on the full frequency band (e.g., schedule the user equipment for a downlink channel and/or an uplink channel on the full frequency band, provide transmission/reception configurations to operate on the full frequency band, indicate timing for downlink and/or uplink on the full frequency band, and so on), and the user equipment may communicate with the network using the full frequency band.

If the user equipment determines that it may not be capable of operating on the full frequency band (e.g., it may not be capable of duplexing the duplex distance associated with the full frequency band), then the user equipment may transmit an indication (e.g. via capability signaling, via modified MPR behavior signaling, or some other method specified in the communications protocol) that it may operate on the partial frequency band (e.g., assuming that it may do so). The network may then configure the user equipment to operate on the partial frequency band (e.g., schedule the user equipment for a downlink channel and/or an uplink channel on the partial frequency band, provide transmission/reception configurations for the partial frequency band, indicate timing for downlink and/or uplink on the partial frequency band, and so on), and the user equipment may communicate with the network using the partial frequency band.

FIG. 1 is a block diagram of user equipment 10, according to embodiments of the present disclosure. The user equipment 10 may include, among other things, one or more processors 12 (collectively referred to herein as a single processor for convenience, which may be implemented in any suitable form of processing circuitry), memory 14, nonvolatile storage 16, a display 18, input structures 22, an input/output (I/O) interface 24, a network interface 26, and a power source 29. The various functional blocks shown in FIG. 1 may include hardware elements (including circuitry), software elements (including machine-executable instructions) or a combination of both hardware and software elements (which may be referred to as logic). The processor 12, memory 14, the nonvolatile storage 16, the display 18, the input structures 22, the input/output (I/O) interface 24, the network interface 26, and/or the power source 29 may each be communicatively coupled directly or indirectly (e.g., through or via another component, a communication bus, a network) to one another to transmit and/or receive data between one another. It should be noted that FIG. 1 is merely one example of a particular implementation and is intended to illustrate the types of components that may be present in the user equipment 10.

By way of example, the user equipment 10 may include any suitable computing device, including a desktop or notebook computer (e.g., in the form of a MacBook®, MacBook® Pro, MacBook Air®, iMac®, Mac® mini, or Mac Pro® available from Apple Inc. of Cupertino, California), a portable electronic or handheld electronic device such as a wireless electronic device or smartphone (e.g., in the form of a model of an iPhone® available from Apple Inc. of Cupertino, California), a tablet (e.g., in the form of a model of an iPad® available from Apple Inc. of Cupertino, California), a wearable electronic device (e.g., in the form of an Apple Watch® by Apple Inc. of Cupertino, California), and other similar devices. It should be noted that the processor 12 and other related items in FIG. 1 may be embodied wholly or in part as software, hardware, or both. Furthermore, the processor 12 and other related items in FIG. 1 may be a single contained processing module or may be incorporated wholly or partially within any of the other elements within the user equipment 10. The processor 12 may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that may perform calculations or other manipulations of information. The processors 12 may include one or more application processors, one or more baseband processors, or both, and perform the various functions described herein.

In the user equipment 10 of FIG. 1, the processor 12 may be operably coupled with a memory 14 and a nonvolatile storage 16 to perform various algorithms. Such programs or instructions executed by the processor 12 may be stored in any suitable article of manufacture that includes one or more tangible, computer-readable media. The tangible, computer-readable media may include the memory 14 and/or the nonvolatile storage 16, individually or collectively, to store the instructions or routines. The memory 14 and the nonvolatile storage 16 may include any suitable articles of manufacture for storing data and executable instructions, such as random-access memory, read-only memory, rewritable flash memory, hard drives, and optical discs. In addition, programs (e.g., an operating system) encoded on such a computer program product may also include instructions that may be executed by the processor 12 to enable the user equipment 10 to provide various functionalities.

In certain embodiments, the display 18 may facilitate users to view images generated on the user equipment 10. In some embodiments, the display 18 may include a touch screen, which may facilitate user interaction with a user interface of the user equipment 10. Furthermore, it should be appreciated that, in some embodiments, the display 18 may include one or more liquid crystal displays (LCDs), light-emitting diode (LED) displays, organic light-emitting diode (OLED) displays, active-matrix organic light-emitting diode (AMOLED) displays, or some combination of these and/or other display technologies.

The input structures 22 of the user equipment 10 may enable a user to interact with the user equipment 10 (e.g., pressing a button to increase or decrease a volume level). The I/O interface 24 may enable user equipment 10 to interface with various other electronic devices, as may the network interface 26. In some embodiments, the I/O interface 24 may include an I/O port for a hardwired connection for charging and/or content manipulation using a standard connector and protocol, such as the Lightning connector provided by Apple Inc. of Cupertino, California, a universal serial bus (USB), or other similar connector and protocol. The network interface 26 may include, for example, one or more interfaces for a personal area network (PAN), such as an ultra-wideband (UWB) or a BLUETOOTH® network, a local area network (LAN) or wireless local area network (WLAN), such as a network employing one of the IEEE 802.11x family of protocols (e.g., WI-FTC)), and/or a wide area network (WAN), such as any standards related to the Third Generation Partnership Project (3GPP), including, for example, a 3^{rd} generation (3G) cellular network, universal mobile telecommunication system (UMTS), 4^{th} generation (4G) cellular network, long term evolution (LTE®) cellular network, long term evolution license assisted access (LTE-LAA) cellular network, 5^{th} generation (5G) cellular network, and/or New Radio (NR) cellular network, a 6^{th} generation (6G) or greater than 6G cellular network, a satellite network, a non-terrestrial network, and so on. In particular, the network interface 26 may include, for example, one or more interfaces for using a Release-15 cellular communication standard of the 5G specifications that include the millimeter wave (mmWave) frequency range (e.g., 24.25-300 gigahertz (GHz)) and/or any other cellular communication standard release (e.g., Release-16, Release-17, any future releases) that define and/or enable frequency ranges used for wireless communication. The network interface 26 of the user equipment 10 may allow communication over the aforementioned networks (e.g., 5G, Wi-Fi, LTE-LAA, and so forth).

The network interface 26 may also include one or more interfaces for, for example, broadband fixed wireless access networks (e.g., WIMAX®), mobile broadband Wireless networks (mobile WIMAX®), asynchronous digital subscriber lines (e.g., ADSL, VDSL), digital video broadcasting-terrestrial (DVB-T®) network and its extension DVB Handheld (DVB-H®) network, ultra-wideband (UWB) network, alternating current (AC) power lines, and so forth.

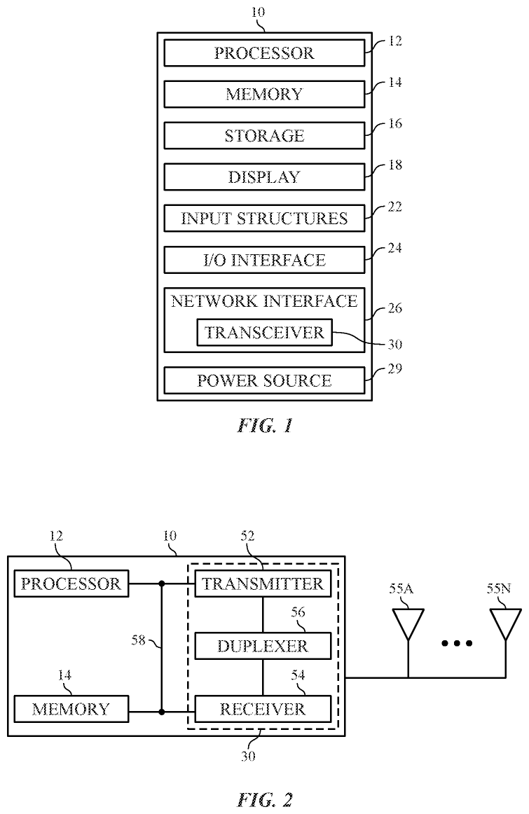

FIG. 2 is a functional diagram of the user equipment 10 of FIG. 1, according to embodiments of the present disclosure. As illustrated, the processor 12, the memory 14, the transceiver 30, a transmitter 52, a receiver 54, and/or antennas 55 (illustrated as 55A-55N, collectively referred to as an antenna 55) may be communicatively coupled directly or indirectly (e.g., through or via another component, a communication bus, a network) to one another to transmit and/or receive data between one another.

The user equipment 10 may include the transmitter 52 and/or the receiver 54 that respectively enable transmission and reception of data between the user equipment 10 and an external device via, for example, a network (e.g., including base stations or access points) or a direct connection. As illustrated, the transmitter 52 and the receiver 54 may be combined into the transceiver 30. The user equipment 10 may also have one or more antennas 55A-55N electrically coupled to the transceiver 30. The antennas 55A-55N may be configured in an omnidirectional or directional configuration, in a single-beam, dual-beam, or multi-beam arrangement, and so on. Each antenna 55 may be associated with one or more beams and various configurations. In some embodiments, multiple antennas of the antennas 55A-55N of an antenna group or module may be communicatively coupled to a respective transceiver 30 and each emit radio frequency signals that may constructively and/or destructively combine to form a beam. The user equipment 10 may include multiple transmitters, multiple receivers, multiple transceivers, and/or multiple antennas as suitable for various communication standards. In some embodiments, the transmitter 52 and the receiver 54 may transmit and receive information via other wired or wireline systems or means.

As illustrated, the transceiver 30 may include a duplexer 56 that enables bidirectional communication over a single path while separating signals in the frequency domain, such that uplink and downlink signals are separated from one another. For example, the duplexer 56 may enable frequency division duplexing (FDD), such that the duplexer may isolate the transmitter 52 from a received signal (e.g., having a first frequency) while isolating a receiver of the user equipment 10 from a transmission signal (e.g., having a second frequency). The duplexer 56 may include an electrical balanced duplexer, a double balanced duplexer, or any other suitable form of duplexer. Moreover, the various components of the user equipment 10 may be coupled together by a bus system 58. The bus system 58 may include a data bus, for example, as well as a power bus, a control signal bus, and a status signal bus, in addition to the data bus. The components of the user equipment 10 may be coupled together or accept or provide inputs to each other using some other mechanism.

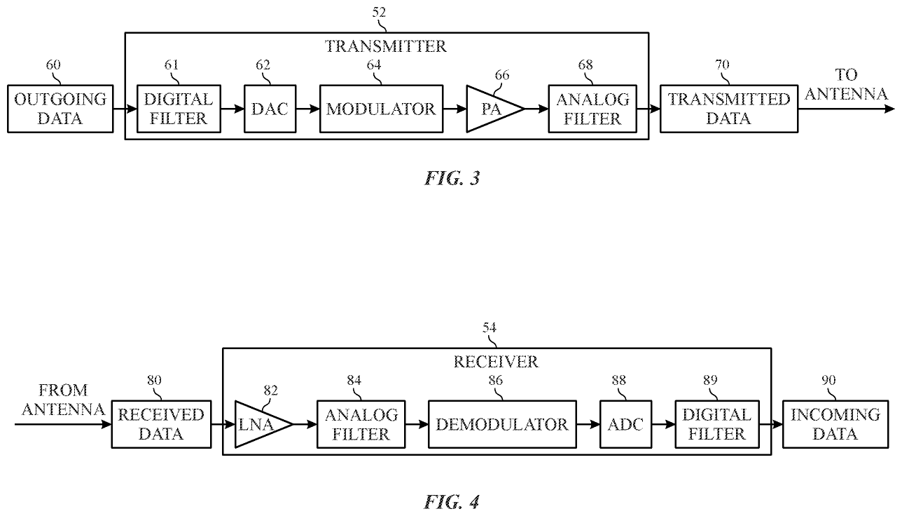

FIG. 3 is a schematic diagram of the transmitter 52 (e.g., transmit circuitry), according to embodiments of the present disclosure. As illustrated, the transmitter 52 may receive outgoing data 60 in the form of a digital signal to be transmitted via the one or more antennas 55. A digital filter 61 (e.g., filter circuitry and/or software) of the transmitter 52 may remove components from the digital signal that are outside of a desired frequency range. In some cases, the digital filter 61 may be tuned to (e.g., filter components outside of) a certain frequency range or fixed step size, such as a radio frequency (RF) channel bandwidth (e.g., 5 MHz, 10 MHz, and so on). In other cases, the digital filter 61 may be tuned to any allocable bandwidth (e.g., 1 MHz or less, 5 MHz or less, 10 MHz or less, and so on). The digital filter 61 may include any suitable filter that performs digital signal processing, including, for example, a linear filter, a causal filter, a time-invariant filter, a stable filter, a finite impulse response (FIR) filter, and so on. A digital-to-analog converter (DAC) 62 of the transmitter 52 may convert the digital signal to an analog signal, and a modulator 64 may combine the converted analog signal with a carrier signal to generate a radio wave. A power amplifier (PA) 66 receives the modulated signal from the modulator 64. The power amplifier 66 may amplify the modulated signal to a suitable level to drive transmission of the signal via the one or more antennas 55. An analog filter 68 (e.g., filter circuitry and/or software) of the transmitter 52 may then remove undesirable noise from the amplified signal to generate transmitted data 70 to be transmitted via the one or more antennas 55. The analog filter 68 may include any suitable filter or filters to remove the undesirable noise from the amplified signal, such as a bandpass filter, a bandstop filter, a low pass filter, a high pass filter, and/or a decimation filter. Additionally, the transmitter 52 may include any suitable additional components not shown, or may not include certain of the illustrated components, such that the transmitter 52 may transmit the outgoing data 60 via the one or more antennas 55. For example, the transmitter 52 may include a mixer and/or a digital up converter. As another example, the transmitter 52 may not include the analog filter 68 if the power amplifier 66 outputs the amplified signal in or approximately in a desired frequency range (such that filtering of the amplified signal may be unnecessary).

FIG. 4 is a schematic diagram of the receiver 54 (e.g., receive circuitry), according to embodiments of the present disclosure. As illustrated, the receiver 54 may receive received data 80 from the one or more antennas 55 in the form of an analog signal. A low noise amplifier (LNA) 82 may amplify the received analog signal to a suitable level for the receiver 54 to process. An analog filter 84 (e.g., filter circuitry and/or software) may remove undesired noise from the received signal, such as cross-channel interference. The analog filter 84 may also remove additional signals received by the one or more antennas 55 that are at frequencies other than the desired signal. The analog filter 84 may include any suitable filter or filters to remove the undesired noise or signals from the received signal, such as a bandpass filter, a bandstop filter, a low pass filter, a high pass filter, and/or a decimation filter. A demodulator 86 may remove a radio frequency envelope and/or extract a demodulated signal from the filtered signal for processing. An analog-to-digital converter (ADC) 88 may receive the demodulated analog signal and convert the signal to a digital signal. A digital filter 89 (e.g., filter circuitry and/or software) of the receiver 54 may remove components from the digital signal that are outside of a desired frequency range to generate incoming data 90 to be further processed by the user equipment 10. In some cases, the digital filter 89 may be tuned to (e.g., filter components outside of) a certain frequency range or fixed step size, such as an RF channel bandwidth (e.g., 5 MHz, 10 MHz, and so on). In other cases, the digital filter 89 may be tuned to any allocable bandwidth (e.g., 1 MHz or less, 5 MHz or less, 10 MHz or less, and so on). The digital filter 89 may include any suitable filter that performs digital signal processing, including, for example, a linear filter, a causal filter, a time-invariant filter, a stable filter, a finite impulse response (FIR) filter, and so on. Additionally, the receiver 54 may include any suitable additional components not shown, or may not include certain of the illustrated components, such that the receiver 54 may receive the received data 80 via the one or more antennas 55. For example, the receiver 54 may include a mixer and/or a digital down converter.

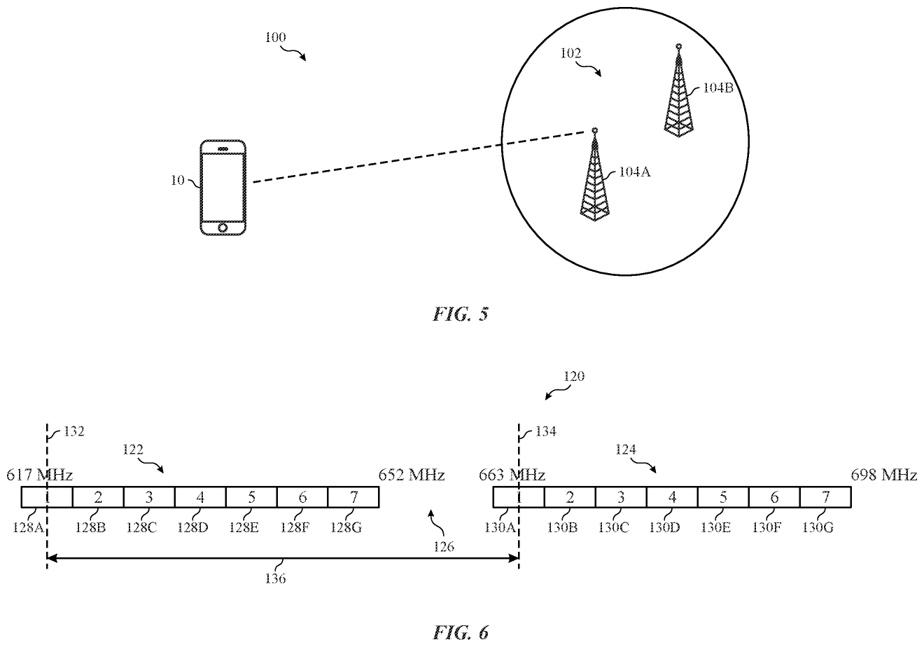

FIG. 5 is a schematic diagram of a communication system 100 including the user equipment 10 of FIG. 1 communicatively coupled to a wireless communication network 102 supported by base stations 104A, 104B (collectively 104), according to embodiments of the present disclosure. In particular, the base stations 104 may include Next Generation NodeB (gNodeB or gNB) base stations and may provide 5G/NR coverage via the wireless communication network 102 to the user equipment 10. The base stations 104 may include any suitable electronic device, such as a communication hub or node, that facilitates, supports, and/or implements the network 102. In some embodiments, the base stations 104 may include Evolved NodeB (eNodeB) base stations and may provide 4G/LTE coverage via the wireless communication network 102 to the user equipment 10. Each of the base stations 104 may include at least some of the components of the user equipment 10 shown in FIGS. 1 and 2, including one or more processors 12, the memory 14, the storage 16, the transceiver 30, the transmitter 52, the receiver 54, and the associated circuitry shown in FIG. 4. It should be understood that while the present disclosure may use 5G/NR as an example specification or standard, the embodiments disclosed herein may apply to other suitable specifications or standards (e.g., such as the 4G/LTE specification). Moreover, the network 102 may include any suitable number of base stations 104 (e.g., one or more base stations 104, four or more base stations 104, ten or more base stations 104, and so on).

As discussed above, the 3GPP specifies certain frequency bands for use with certain RATs. For example, the 3GPP specifies the 600 MHz frequency band for use by FR1 per 5G/NR RAT as the n71 frequency band in at least some geographical regions (e.g., the United States). FIG. 6 is a frequency diagram of the n71 frequency band 120. As illustrated, the n71 band includes a first 35 MHz wide frequency range for downlink 122 (e.g., from 617 MHz to 652 MHz) and a second 35 MHz wide frequency range for uplink 124 (e.g., from 663 MHz to 698 MHz). At least some regional regulatory forums or interest groups, such as Asia Pacific Telecommunity (APT), desire to specify a new frequency band to use the 600 MHz frequency band in the APT region (e.g., the Asia Pacific geographical region). While the 600 MHz and the n71 frequency bands are referenced in this disclosure, it should be understood that any of the disclosed embodiments may apply to any suitable frequency range.

In the simplest example, for these other operators, the 600 MHz frequency band may be designated as the n71 frequency band 120, as shown in FIG. 6. However, because the 600 MHz frequency band has more bandwidth to be used than the total width of that of the n71 frequency band 120 (e.g., even when including a guard band or duplex gap 126 of, for example 11 MHz), it may be more efficient to expand usage of the 600 MHz frequency band beyond the usage defined by the n71 frequency band 120. For example, each of the two 35 MHz wide frequency ranges 122, 124 may be extended by 5 MHz, such that a first 40 MHz frequency range (e.g., including 122) is used for downlink, and a second 40 MHz frequency range (e.g., including 124) is used for uplink. However, the duplexer 56 of the user equipment 10 may be configured to duplex or separate downlink signals from uplink signals based on their respective frequency ranges (e.g., a difference between center frequencies of a downlink channel and an uplink channel, also referred to as a duplex distance).

For example, as illustrated in FIG. 6, in the n71 frequency band 120, the downlink range 122 is divided into seven 5 MHz wide channels 128A-G (collectively 128) and the uplink range 124 is divided into seven 5 MHz wide channels 130A-G (collectively 130). The network 102 may assign a downlink channel 128/uplink channel 130 pair to maintain a consistent duplex distance between the assigned downlink channel 128 and the assign uplink channel 130, such that the duplexer 56 may duplex any downlink channel 128/uplink channel 130 pair. In particular, each channel includes a center frequency. For example, the center frequency 132 of downlink channel 1 128A having a bandwidth of 5 MHz (e.g., from 617 MHz to 622 MHz) is 619.5 MHz. The center frequency 134 of uplink channel 1 130A having a bandwidth of 5 MHz (e.g., from 663 MHz to 668 MHz) is 665.5 MHz. A duplex distance 136 between the center frequencies is 46 MHz (e.g., a difference between the center frequencies 665.5 MHz and 619.5 MHz). As such, user equipment 10 having a duplexer 56 and the transceiver 30 configured to duplex a duplex distance 136 of 46 MHz may duplex or separate signals received on the downlink channel 1 128A from signal transmitted on the uplink channel 1 130A, signals received on the downlink channel 2 128B from signal transmitted on the uplink channel 2 130B, and so on. That is, as long as corresponding channels (e.g., 128A and 130A, 128B and 130B, and so on) are allocated, the duplexer 56 together with the transceiver 30 may duplex between signals on the downlink channel 128/uplink channel 130 pair, as the duplex distance 136 remains 46 MHz.

However, if channels other than corresponding channels are allocated to the user equipment 10, then the transceiver 30 may not duplex the allocated downlink channel 128/uplink channel 130 pair, as it may be configured to only duplex a certain duplex distance (e.g., 46 MHz). As such, a proposal to simply extend the n71 frequency band 120 by 5 MHz in each direction (e.g., 5 MHz added to the beginning of the 40 MHz downlink frequency range 122, and 5 MHz added to the end of the 40 MHz uplink frequency range 124), then the downlink channels 128 would add a new downlink channel 1 from 612 MHz to 617 MHz having a center frequency of 614.5 MHz (and incrementing the downlink channels 128 of the n71 frequency band 120 by 1), while the uplink channels 130 would add a new uplink channel 8 from 698 MHz to 703 MHz having a center frequency of 700.5 MHz. Accordingly, the duplex distance between corresponding channels (e.g., downlink channel 1 and uplink channel 1, downlink channel 2 and uplink channel 2, and so on) would change from 46 MHz to 51 MHz. That is, taken as an example, a center frequency of the new downlink channel 1 would be 614.5 MHz, and the center frequency of the uplink channel 1 130A remains 665.5 MHz. As such, the duplex distance for the extended frequency range would be 51 MHz (e.g., a difference between the center frequencies of 614.5 MHz and 665.5 MHz). While current or previous model (e.g., legacy) devices may have duplexers 56 and transceivers 30 that are configured to operate on and duplex the n71 frequency band 120 (e.g., 35 MHz wide and a duplex distance of 46 MHz), such devices may not have duplexers 56 and a transceiver 30 that are configured to operate on and duplex this extended frequency range (e.g., 40 MHz wide and a duplex distance of 51 MHz).

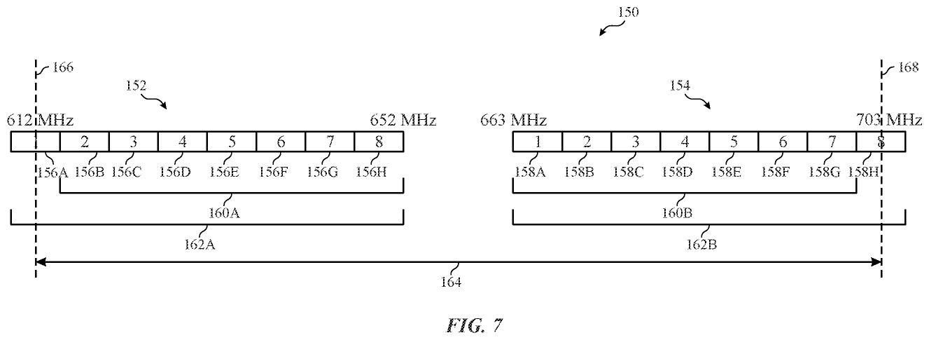

Instead, the disclosed embodiments may include providing a 600 MHz frequency range that extends each of the downlink frequency range 122 and the uplink frequency range 124 of the n71 frequency band 120 by 5 MHz, but enables duplex distances or spacing that matches or correlates to the n71 frequency band 120 of 46 MHz for certain downlink/uplink channel pairs (e.g., such that legacy devices may duplex the downlink channel 128/uplink channel 130 pair), and enables new duplex distances or spacing (e.g., of 86 MHz) for other downlink/uplink channel pairs (e.g., such that new or non-legacy devices may have duplexers 56 that are configured to duplex the new duplex distances). FIG. 7 is a frequency diagram of a frequency band 150 in the 600 MHz frequency range, according to embodiments of the present disclosure. As illustrated, the frequency band 150 includes a downlink frequency range 152 having channels 156A-H (collectively 156) and an uplink frequency range 154 having channels 158A-H (collectively 158), where the downlink frequency range 152 extends the downlink frequency range 122 of the n71 frequency band 120 shown in FIG. 6 by 5 MHz by adding new downlink channel 1 156A (e.g., from 612 MHz to 617 MHz), and the uplink frequency range 154 extends the uplink frequency range 124 of the n71 frequency band 120 by 5 MHz by adding new channel 8 158H (e.g., from 698 MHz to 703 MHz). As such, the frequency band 150 ranges from 612 MHz to 703 MHz, including the downlink frequency range 152 ranging from 612 MHz to 652 MHz, and the uplink frequency range 154 ranging from 663 MHz to 703 MHz.

For user equipment 10 (e.g., legacy devices) that may be capable of operating on the n71 frequency band 120 and/or duplex a duplex distance 136 of 46 MHz, the network 102 may allocate downlink channel 156B-H in a portion 160A of the downlink frequency range 152 and an uplink channel 158A-G in a portion 160B of the uplink frequency range 154 that matches or correlates to the n71 frequency band 120. In particular, these downlink channel 156/uplink channel 158 pairs may have a duplex distance of 46 MHz, matching or correlating to that of the n71 frequency band 120, thus enabling the legacy user equipment 10 to operate using the downlink channel 156/uplink channel 158 pairs, as their duplexers 56 may already be configured to operate with the duplex distance of 46 MHz. These downlink channel 156/uplink channel 158 pairs may then include 156B and 158A, 156C and 158B, 156D and 158C, 156E and 158D, 156F and 158E, 156G and 158F, and 156H and 158G. The portion 160A of the downlink frequency range 152 and the portion 160B of the uplink frequency range 154 that may be allocated to the legacy user equipment 10 may be collectively referred to as a partial frequency band 160. As such, the frequency band 150 ranges from 612 MHz to 703 MHz, including the portion 160A of the downlink frequency range 152 ranging from 617 MHz to 652 MHz, and the portion 160B of the uplink frequency range 154 ranging from 663 MHz to 698 MHz.

For user equipment 10 that was designed to operate on the frequency band 150, the network 102 may allocate the same downlink channel 156/uplink channel 158 pairs that may be allocated to the legacy user equipment 10, but may also or alternatively allocate the downlink channel 156A and the uplink channel 158H as a pair. The duplex distance 164 between a center frequency 166 of the downlink channel 1 156A (e.g., 614.5 MHz) and a center frequency 168 of the uplink channel 8 158H (e.g., 700.5 MHz) is 86 MHz (e.g., a difference between the center frequencies 166, 168). As such, the duplexer 56 and transceiver 30 of such user equipment 10 may be capable of duplexing 46 MHz, while in a second configuration the duplexer 56 and the transceiver 30 may be capable of duplexing 86 MHz, though, in some embodiments, the duplexer and transceiver may be configured to use a variable duplex spacing. The downlink channels 156 that may be allocated to such user equipment 10 may be characterized as part of a full or complete downlink frequency range 162A, and the uplink channels 158 that may be allocated to such user equipment 10 may be characterized as part of a full or complete uplink frequency range 162B. The full downlink frequency range 162A and the full uplink frequency range 162B that may be allocated to such user equipment 10 may be collectively referred to as a full frequency band 162.

It should be understood that, in some embodiments, the network 102 may allocate any suitable downlink channel 156/uplink channel 158 pairs having any suitable duplex distance that the user equipment 10 may be able to duplex. For example, if the user equipment 10 uses a duplex spacing of 56 MHz, then the network 102 may allocate downlink channel 1 156A with uplink channel 2 158B. As another example, if the user equipment 10 uses a duplex spacing of 51 MHz, then the network 102 may allocate downlink channel 1 156A with uplink channel 1 158A. However, for the legacy user equipment 10 that may only operate with a duplex spacing of 46 MHz, but may not be capable of using other duplex distances associated with the frequency band 150 (e.g., 56 MHz in the case of downlink channel 1 156A and uplink channel 2 158B, 86 MHz in the case of downlink channel 1 156A and uplink channel 8 158H), the network 102 may allocate the downlink channel 156/uplink channel 158 pairs having a duplex distance of 46 MHz.

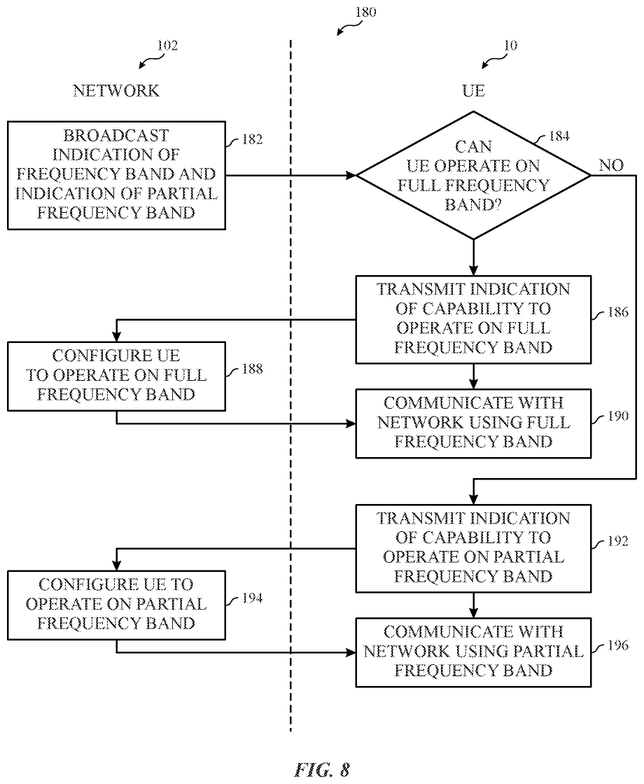

FIG. 8 is a flowchart of a method 180 to allocated channels 156, 158 of the frequency band 150 of FIG. 6, according to embodiments of the present disclosure. Any suitable device (e.g., a controller) that may control components of the user equipment (UE) 10, the network 102, and/or the base stations 104, such as the processor 12, may perform the method 180. In some embodiments, the method 180 may be implemented by executing instructions stored in a tangible, non-transitory, computer-readable medium, such as the memory 14 or storage 16, using the processor 12. For example, the method 180 may be performed at least in part by one or more software components, such as an operating system of the user equipment 10, the network 102, and/or the base stations 104, one or more software applications of the user equipment 10, the network 102, and/or the base stations 104, and the like. While the method 180 is described using steps in a specific sequence, it should be understood that the present disclosure contemplates that the described steps may be performed in different sequences than the sequence illustrated, and certain described steps may be skipped or not performed altogether.

In process block 182, the network 102 and/or the base station 104 broadcasts or transmits an indication of the frequency band 150 (e.g., the full frequency band 162) and an indication of a partial frequency band 160. As described above, the full frequency band 162 may include a greater range than the partial frequency band 160. The partial frequency band 160 may be compatible with certain (e.g., legacy) user equipment 10, such as user equipment 10 that may operate on the n71 frequency band 120 using a duplexer 56 and transceiver 30 that may duplex downlink channel/uplink channel pairs having a duplex distance of 46 MHz. On the other hand, the full frequency band 162 may be compatible with other (e.g., more recent) user equipment 10, such as those that were designed to use the full frequency band 162 (e.g., those that may have a duplexer 56 and transceiver 30 that may duplex downlink channel/uplink channel pairs having a different duplex distance, such as 51 MHz, 56 MHz, 86 MHz, and so on). In some cases, the partial frequency band 160 may be applicable to certain geographical regions (e.g., the United States), while the full frequency band 162 may be applicable to other geographical regions (e.g., the Asia Pacific region). In some embodiments, the indication of the full frequency band 162 may be included in a system information block (e.g., as defined by the 3GPP) broadcasted by the base station 104, and the indication of the partial frequency band 160 may be included in a multiple frequency band indicator (e.g., as defined by the 3GPP), which may be part of the system information block.

The user equipment 10 may receive the broadcasted indications, and, in decision block 184, determine whether it may operate on the full frequency band 162. For example, the user equipment 10 may determine whether it may duplex downlink channel/uplink channel pairs having a different duplex distance than that associated with the n71 frequency band 120 or 46 MHz, such as 51 MHz, 56 MHz, 86 MHz, and so on. If so, in process block 186, the user equipment 10 transmits an indication that it may operate on the full frequency band 162 to the base station 104. In process block 188, the network 102 then configures the user equipment 10 to operate on the full frequency band 162. For example, the network 102 may schedule the user equipment 10 for a downlink channel 156 and/or an uplink channel 158 on the full frequency band 162, provide transmission/reception configurations to operate on the full frequency band 162, indicate timing for downlink and/or uplink on the full frequency band 162, and so on. In some embodiments, the network 102 may either allocate to the user equipment 10 a downlink channel 156/uplink channel 158 pair that is separated by a duplex distance of 46 MHz (e.g., 156B and 158A, 156C and 158B, 156D and 158C, 156E and 158D, 156F and 158E, 156G and 158F, or 156H and 158G), or allocate the downlink channel 156A and the uplink channel 158H that is separated by a duplex distance of 86 MHz as a pair. However, in additional or alternative embodiments, the network 102 may allocate any suitable downlink channel 156/uplink channel 158 pair having any suitable duplex distance that the user equipment 10 may be able to duplex.

In any case, the network 102 may transmit the configuration or schedule (e.g., an indication of a downlink channel 156/uplink channel 158 pair) to the user equipment 10, the user equipment 10 may receive the configuration or schedule, and then the processor 12 of the user equipment 10 may configure its transmitter 52 or receiver 54 settings based on (e.g., according to, to conform with) the configuration or schedule. In process block 190, the user equipment 10 communicates with the network 102 using the full frequency band 162 based on the configuration or schedule.

Returning back to decision block 184, if the user equipment 10 determines that it may not be capable of operating on the full frequency band 162 (e.g., it may not be capable of duplexing the duplex distances associated with the full frequency band 162, including 51 MHz, 56 MHz, 86 MHz, and so on), then, in process block 192, the user equipment 10 transmits an indication that it may operate on the partial frequency band 160 (e.g., assuming that it may do so). That is, if the user equipment 10 determines that it may operate on the partial frequency band 160, then it may transmit the indication. In cases where the user equipment 10 may not be able to operate on either the full frequency band 162 or the partial frequency band 160, then the user equipment 10 may indicate that it may not operate on either band 162, 160 to the base station 104 and/or exit the method 180. In process block 194, the network 102 may then configure the user equipment 10 to operate on the partial frequency band 160. For example, the network 102 may schedule the user equipment 10 for a downlink channel 156 and/or an uplink channel 158 on the partial frequency band 160, provide transmission/reception configurations for the partial frequency band 160, indicate timing for downlink and/or uplink on the partial frequency band 160, and so on. In particular, the network 102 may schedule the user equipment 10 for a downlink channel 156 and/or an uplink channel 158 on the partial frequency band 160 having a duplex distance of 46 MHz (e.g., 156B and 158A, 156C and 158B, 156D and 158C, 156E and 158D, 156F and 158E, 156G and 158F, or 156H and 158G).

In any case, the network 102 may transmit the configuration or schedule (e.g., an indication of a downlink channel 156/uplink channel 158 pair) to the user equipment 10, the user equipment 10 may receive the configuration or schedule, and then the processor 12 of the user equipment 10 may configure its transmitter 52 or receiver 54 settings based on (e.g., according to, to conform with) the configuration or schedule. In process block 196, the user equipment 10 communicates with the network 102 using the partial frequency band 160 based on the configuration or schedule.

In this manner, the method 180 may enable the network 102 to allocate channels 156, 158 of the frequency band 150 of FIG. 6 to both legacy user equipment 10 that may not be capable of operating on the full frequency band 162 and more current user equipment 10 that may be capable of operating on the full frequency band 162. In particular, channels 156, 158 of the partial frequency band 160 having a duplex distance of 46 MHz may be allocated to the legacy user equipment 10, while such channels may also be allocated to the more current user equipment 10, as may channels having other duplex distances (e.g., downlink channel 1 156A and uplink channel 8 158H having a duplex distance of 86 MHz).

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ,” it is intended that such elements are to be interpreted under 35 U.S.C. 112(f). However, for any claims containing elements designated in any other manner, it is intended that such elements are not to be interpreted under 35 U.S.C. 112(f).

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. An electronic device, comprising:
a transmitter configured to transmit a transmission signal to user equipment;
a receiver configured to receive a receive signal from the user equipment; and
processing circuitry configured to
transmit, via the transmitter, a first indication of a frequency band and a partial frequency band to the user equipment, the frequency band comprising the partial frequency band,
receive, via the receiver, a second indication of a capability of the user equipment to operate on the frequency band or the partial frequency band;
configure, via the transmitter, the user equipment for operation on the frequency band based on the second indication indicating that the user equipment is capable of operating on the frequency band, and
configure, via the transmitter, the user equipment for operation on the partial frequency band based on the second indication indicating that the user equipment is capable of operating on the partial frequency band.

2. The electronic device of claim 1, wherein the processing circuitry is configured to communicate, via the transmitter or the receiver, with the user equipment on the frequency band based on configuring the user equipment for operation on the frequency band.

3. The electronic device of claim 1, wherein the processing circuitry is configured to communicate, via the transmitter or the receiver, with the user equipment on the partial frequency band based on configuring the user equipment for operation on the partial frequency band.

4. The electronic device of claim 1, wherein the frequency band comprises 612 megahertz (MHz) to 703 MHz.

5. The electronic device of claim 1, wherein the frequency band comprises a downlink frequency range ranging from 612 MHz to 652 MHz, and an uplink frequency range ranging from 663 MHz to 703 MHz.

6. The electronic device of claim 1, wherein the partial frequency band comprises 617 megahertz (MHz) to 698 MHz.

7. The electronic device of claim 1, wherein the partial frequency band comprises a downlink frequency range ranging from 617 MHz to 652 MHz, and an uplink frequency range ranging from 663 MHz to 698 MHz.

8. The electronic device of claim 1, wherein the partial frequency band correlates to an n71 frequency band as defined by a 5^{th} generation/New Radio specification.

9. A method performed by user equipment, comprising:
receiving, at a receiver of the user equipment, a first indication of a frequency band and a partial frequency band, the frequency band comprising the partial frequency band;
transmitting, by a transmitter of the user equipment, a second indication of a capability of operating on the frequency band or the partial frequency band;
receiving, at the receiver, a configuration based on the second indication; and
communicating, using the transmitter or the receiver, based on the configuration.

10. The method of claim 9, comprising determining, using processing circuitry of the user equipment, a capability of operating on the frequency band.

11. The method of claim 10, wherein the second indication indicates the capability of operating on the frequency band.

12. The method of claim 9, comprising determining, using processing circuitry of the user equipment, a capability of operating on the partial frequency band and not the frequency band.

13. The method of claim 12, wherein the second indication indicates the capability of operating on the partial frequency band.

14. The method of claim 9, wherein the configuration comprises a downlink channel and an uplink channel.

15. The method of claim 14, wherein a duplex distance between a center frequency of the downlink channel and a center frequency of the uplink channel comprises 46 megahertz.

16. One or more tangible, non-transitory, machine-readable media, storing instructions configured to cause processing circuitry of a base station to:
transmit, using a transmitter of the base station, a first indication of a frequency band and a partial frequency band to user equipment,
receive, using a receiver of the base station, a second indication of a capability of the user equipment to operate on the frequency band or the partial frequency band;
transmit, using the transmitter, a configuration to the user equipment enabling operation on the frequency band, and communicate, using the transmitter or the receiver, with the user equipment using the frequency band based on the second indication indicating that the user equipment is capable of operating on the frequency band; and
transmit, using the transmitter, a configuration to the user equipment enabling operation on the partial frequency band, and communicate, using the transmitter or the receiver, with the user equipment using the partial frequency band based on the second indication indicating that the user equipment is capable of operating on the partial frequency band.

17. The one or more tangible, non-transitory, machine-readable media of claim 16, wherein the frequency band comprises the partial frequency band.

18. The one or more tangible, non-transitory, machine-readable media of claim 16, wherein the instructions are configured to cause the processing circuitry to transmit, using the transmitter, the first indication of the frequency band as a part of a system information block.

19. The one or more tangible, non-transitory, machine-readable media of claim 16, wherein the instructions are configured to cause the processing circuitry to transmit, using the transmitter, the first indication of the partial frequency band as a part of a multiple frequency band indicator.

20. The one or more tangible, non-transitory, machine-readable media of claim 16, wherein the second indication indicates that the user equipment is capable of operating on the frequency band, and wherein the configuration comprises a third indication of a downlink channel and a fourth indication of an uplink channel, a duplex distance between the downlink channel and the uplink channel being 86 megahertz.
